(19) United States
(12) Patent Application Publication
(10) Pub. No.: US 2005/0091452 A1
(43) Pub. Date: Apr. 28, 2005

(54) System and method for reducing data loss in disk arrays by establishing data redundancy on demand

(76) Inventors: Ying Chen, San Jose, CA (US); Windsor W. Hsu, Sunnyvale, CA (US); Honest C. Young, Saratoga, CA (US)

Correspondence Address: Frederick W. Gibb, III;McGinn & Gibb, PLLC, Suite 304, 2568-A Riva Road, Annapolis, MD, 21401, US

(21) Appl. No.: 10/695,475

(22) Filed: Oct. 28, 2003

(51) Int. Cl. G06F 12/00

(52) U.S. Cl. 711/114

(57) ABSTRACT

Disclosed is a system and method for reducing data loss in a disk array comprising computing redundant data of the user data in the disk array, periodically storing the computed redundant data into data blocks located on at least one disk; monitoring the disks for a number of concurrent actual and predicted disk failures to occur; determining which portions of the redundant data have been altered since an immediate previous time the redundant data was stored; re-computing altered portions of the redundant data and updating the corresponding data blocks when said number of concurrent disk failures occur and less than a fraction of the redundant data has been altered, reconstructing data stored on a failed disk onto at least one replacement disk; and marking the recomputed redundant data in a directory, wherein the disk array comprises one of the standard RAID arrays.

### BACKGROUND OF THE INVENTION

1. Field of the Invention

The present invention generally relates to reducing the probability and amount of data lost when some of the disks in an array of disks fail.

2. Description of the Related Art

Within this application several publications are referenced by arabic numerals within brackets. Full citations for these and other publications may be found at the end of the specification immediately preceding the claims. The disclosures of all these publications in their entireties are hereby expressly incorporated by reference into the present application for the purposes of indicating the background of the present invention and illustrating the state of the art.

Disks are often organized into arrays for performance and manageability reasons. But when one or more of the disks in the array fails, some of the user data stored in the array is lost. The conventional approach taken to overcome this potential data loss problem is to store some redundant information in the array such that the user data can be recovered when some of the disks fail. For instance, suppose there are n disks worth of user data. The parity is computed by taking the exclusive-or of the corresponding blocks from each of the n disks and then the parity is stored on an additional disk, when any one of the n+1 disks fails, the data on the failed disk would be able to be reconstructed by taking the exclusive-or of the corresponding blocks from the remaining n disks. Conventionally, such a scheme is known as RAID-4 [1]. The parity is one example of an error-correcting code. To tolerate more failures, other codes that contain more redundant information and that require more space to store could be used. For example, in double parity, two additional disks would be needed but an array that uses double parity would be able to tolerate any two disk failures. Also, an exact copy of the user data could be made and stored on n additional disks. This is known as mirroring or RAID-0[1].

In general, as the number of disk failures that the array can tolerate without losing user data increases, more redundant information would have to be stored. More importantly, the redundant information would have to be computed and updated every time the user data is written or updated. Such a technique is extremely costly and not very efficient. In a RAID-4 or RAID-5 system, every update of user data would typically require two disk read and two disk write operations. In the double-parity schemes, every update could require six or more disk operations. Therefore, most conventional systems take the approach of tolerating only a single disk failure.

However, there are several trends in the industry that make single-disk-failure fault-tolerance progressively less sufficient. First, an increasingly number of disks are being grouped into an array so that the chances of having multiple disk failures within an array is increasing. Second, disks are growing in capacity faster than they are improving in data rate. As a result, the time to rebuild the data on a failed disk is increasing over time, and this lengthens the window during which the array could be vulnerable to a subsequent disk failure. Third, disk vendors are continuing to push areal density aggressively. Historically, this has caused a reduction in disk reliability, which is expected to continue in the future. Fourth, the cost of a multiple-disk failure is ever-increasing. Techniques like virtualization, which can spread a host LUN (logical unit number) across many disk arrays, increase the impact to the user of a multiple disk failure because many more host LUNs could be impacted.

One way to reduce the probability of data loss without incurring significant amounts of additional storage and performance cost is to reduce the repair time. The basic idea is that as long as another failure does not occur before the failed disks have been repaired, data is not lost. Most systems today have spare disks in the system so that whenever a disk failure occurs, the rebuild process is immediately started to recover data stored on the failed disk onto a spare disk. The rebuild process itself can be quickened by using techniques, such as distributed spares [2] that attempt to balance the rebuild workload among all the disks in the array. Unfortunately, such conventional techniques are still insufficient, given the industry trends discussed above. An orthogonal approach is to attempt to recover only the blocks that contain user data and not the unused blocks. However, at the block storage level, it is difficult to distinguish between blocks that contain user data and those that are unused. Furthermore, a disk array, in normal operation, is likely to hold a significant amount of user data. Therefore, there remains a great need to dramatically reduce the time needed to re-achieve the desired level of data redundancy after one or more disks in a disk array has failed in order to greatly reduce the chances of data loss.

### SUMMARY OF THE INVENTION

The invention provides a method for reliably storing data on disks comprising writing a data block to be stored in a disk array, combining an address of the data block to a set of retrievable addresses, periodically computing a function of the data stored in the disk array, storing the computed function on at least one disk, on a number of disk failures in the disk array, updating the computed function using the set of retrievable addresses to recompute altered portions of the function, and deleting the set of retrievable addresses, wherein the number of disk failures include disk failures that are predicted to occur, wherein the function is a mathematical function, and wherein the function is an error correcting code. The address of the data block is an address of a corresponding portion of the computed function and the set of retrievable addresses comprises a set of addresses that describe portions of the computed function requiring updating, and the disk array comprises at least one a RAID array. The method further comprises reconstructing data stored on a failed disk onto at least one replacement disk. Moreover, the steps of updating and deleting are skipped if the set of retrievable addresses exceeds a fraction of the data stored in the disk array. Additionally, the computed function is stored on at least one spare disk, and altered portions of the computed function are updated whenever a load on the disk array is below a threshold value. Also, altered portions of the computed function that are less likely to be altered again are preferentially updated.

Alternatively, the invention provides a method of reducing data loss in a disk array comprising periodically storing redundant data into data blocks located on a disk, monitoring the disks in the disk array for a number of disk failures to occur, determining which of the data blocks contain redundant data that has been altered since an immediate previous time the redundant data was stored, recomputing altered portions of the redundant data, and storing the recomputed altered portions in the data blocks, wherein the number of disk failures include disk failures that are predicted to occur. The method further comprises updating the data blocks comprising altered redundant data when the number of disk failures have occurred, and reconstructing data stored on a failed disk onto at least one replacement disk. Moreover, the disk array comprises at least one a RAID array. The step of updating the data blocks comprising altered redundant data is skipped if a number of the data blocks exceeds a fraction of the data stored in the disk array. Additionally, the redundant data is stored on at least one spare disk, and the data blocks containing altered redundant data are updated whenever the load on the disk array is below a threshold value. Furthermore, the data blocks containing altered redundant data that is less likely to be altered again are preferentially updated.

In another embodiment, the invention provides a system for reducing data loss in a disk array comprising a storage unit operable for periodically storing redundant data into data blocks located on a disk, a monitor operable for monitoring the disks in the array for a number of disk failures to occur, a directory operable for determining which of the data blocks contain redundant data that has been altered since an immediate previous time the redundant data was stored, and a computer operable for computing redundant data of the data stored in the disk array and for recomputing altered portions of the redundant data, wherein the number of disk failures monitored include disk failures that are predicted to occur. The system further comprises a controller operable for updating the redundant data when the number of disk failures have occurred, at least one replacement disk operable for storing reconstructed data previously stored on a failed disk, and at least one spare disk operable for storing the redundant data, wherein the directory is operable for marking the recomputed redundant data in the directory. Moreover, the disk array comprises at least one a RAID array. The system further comprises a controller operable for updating the redundant data whenever the load on the disk array is below a threshold value, wherein the controller preferentially updates redundant data that is less likely to be altered again.

The advantages of the invention are numerous. Currently, to increase the number of disk failures that a disk array can tolerate without losing user data, it is necessary to use more disk space to store more redundant data, and more importantly, the additional redundant data would have to be computed and updated every time the user data is written. This is very costly (e.g., multiple reads and multiple writes). Therefore, most systems tolerate only a single disk failure. However, multi-disk failures are increasing and they are costly. In one aspect, the invention makes it possible to achieve higher levels of fault tolerance without incurring significant extra disk space and operations to maintain the redundant data. In another aspect, the invention reduces the time and data processing needed to re-achieve desired levels of data redundancy after one or more disks in a disk array has failed in order to reduce the chance and amount of data loss.

In order to achieve this, the invention periodically computes redundant data and stores the computed data preferably on the spare disks in the system. Then when needed (on demand) such as when disks fail or are predicted to fail, the invention updates the redundant data by recomputing and writing only the parts that have changed. Predicted disk failures are disk failures that are believed likely to occur within a time interval. Methods of predicting disk failures are known in the art [6]. Since the amount of user data that is updated tends to be very small, on the order of a few percent (<5%) per day [3], this, in effect, dramatically decreases the time needed to re-achieve data redundancy. Compared to a traditional system that always keeps all the redundant data updated, the invention, in contrast, provides performance in which much fewer operations are performed since many blocks containing user data are written more than once (the write traffic is much higher than the write working set). Moreover, the invention allows the system to defer most of the operations for updating the redundant data to a more convenient time so that there is dramatically less impact on foreground performance.

Currently, most of the data loss situations in the widely-used RAID-5 array [1] result (1) when there is more than one concurrent disk failure, and (2) when there is one disk failure followed by a subsequent failed sector read on another disk during the rebuild process to recover the user data that was on the failed disk. The invention makes it unnecessary to read most (>95%) of the user data to re-achieve data redundancy after a disk failure in the RAID-5 array. It therefore dramatically reduces the second type of data loss situations. By greatly reducing the amount of data that has to be processed to re-achieve data redundancy, the invention also re-establishes data redundancy much quicker so that the first type of data loss situations is much less likely to occur.

These, and other aspects and advantages of the invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a flow diagram illustrating a preferred method of the invention;

FIG. 2 is a flow diagram illustrating an alternative method of the invention; and

FIG. 3 is a system diagram of the invention.

### DETAILED DESCRIPTION OF PREFERRED EMBODIMENTS OF THE INVENTION

The present invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

As mentioned, there remains a great need to dramatically reduce the time and data processing needed to re-achieve the desired level of data redundancy after one or more disks in a disk array has failed so that the chances of data loss is greatly reduced. The invention addresses such a need. The invention is based on the observation that the amount of user data that is updated tends to be very small, on the order of a few percent (<5%) per day [3]. Therefore, if the additional redundant data is periodically computed and then when needed (on demand), the redundant data is updated by re-computing only the parts that have changed, the time and data processing needed to re-achieve data redundancy would be able to be dramatically decreased. The extra redundant data is preferably stored on one or more additional disks. As previously discussed, disk arrays today have spare disks in the system and these could be used to store the extra redundant data in which case the otherwise empty spares would be preloaded with useful data.

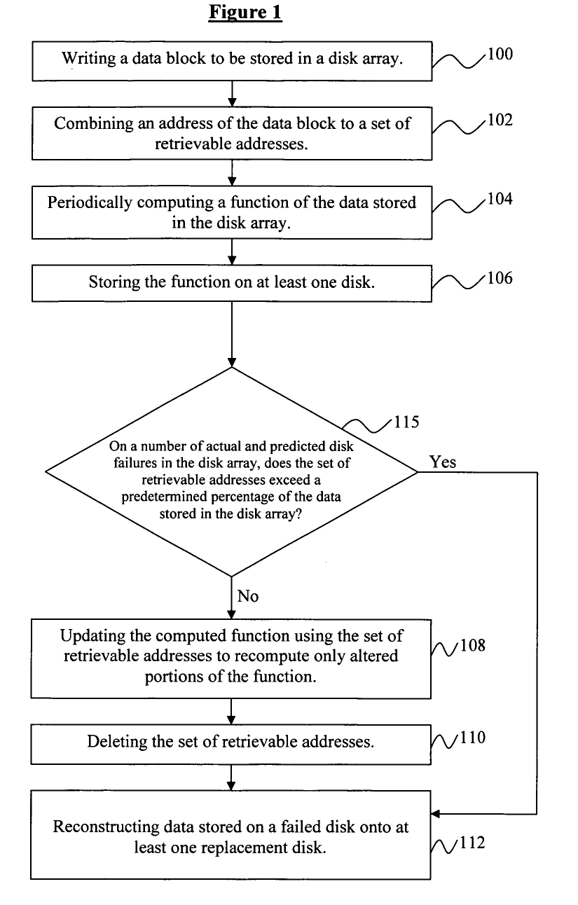

Referring now to the drawings, and more particularly to FIGS. 1 through 3 there are shown preferred embodiments of the invention. As illustrated in the flow diagram of FIG. 1 a method for reliably storing data on disks comprises writing 100 a data block to be stored in a disk array, combining 102 an address of the data block to a set of retrievable addresses, periodically computing 104 a function of the data stored in the disk array, storing 106 the computed function on at least one disk, on a number of predicted and actual disk failures in the disk array, updating 108 the computed function using the set of retrievable addresses to recompute only altered portions of the computed function, deleting 110 the set of retrievable addresses, and reconstructing 112 data stored on a failed disk onto at least one replacement disk. Moreover, the function is a mathematical function. Specifically, the function is an error correcting code. Also, the address of the block is the address of the corresponding portion of the computed function and the set of retrievable addresses comprises a set of addresses that describe the portions of the function requiring updating. Additionally, the disk array comprises one of the standard RAID arrays [1]. Furthermore, the steps of updating 108 and deleting 110 are skipped, in a decision step 115, if the set of retrievable addresses exceeds a fraction of the data stored in the disk array. Also, the computed function is stored on at least one replacement disk.

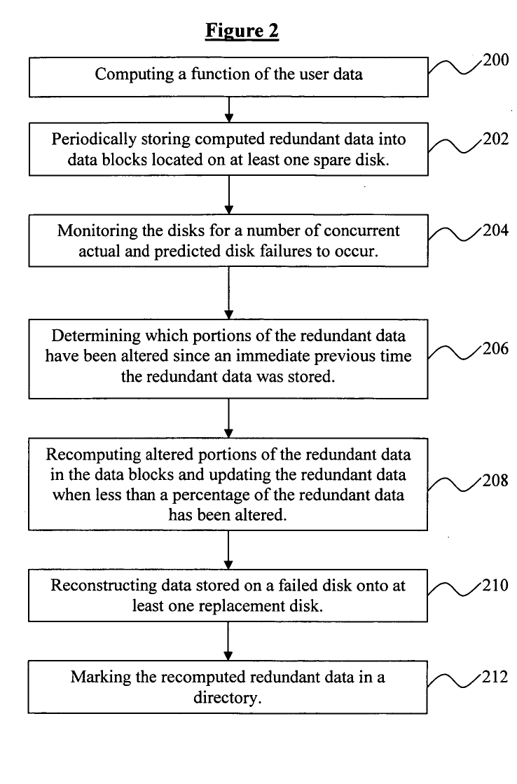

Alternatively, as illustrated in the flow diagram of FIG. 2, the invention provides a method of reducing data loss in a disk array comprising computing 200 redundant data of the user data in the disk array, periodically storing 202 the computed redundant data into data blocks located on at least one disk, monitoring 204 the disks for a number of concurrent actual and predicted disk failures to occur, determining 206 which portions of the redundant data have been altered since an immediate previous time the redundant data was stored, wherein a portion of the redundant data is considered altered if the corresponding portion of the user data is altered, simultaneously recomputing 208 altered portions of the redundant data, and updating the redundant data in the data blocks when the number of concurrent disk failures occur and less than a fraction of the redundant data has been altered, reconstructing 210 data stored on a failed disk onto at least one replacement disk, and marking 212 the recomputed redundant data in a directory, wherein the disk array comprises one of the standard RAID arrays [1].

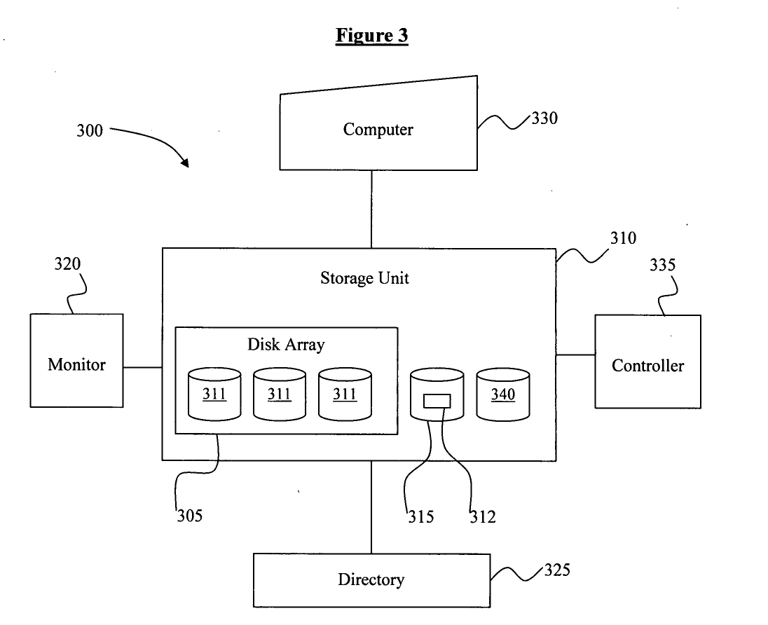

In another embodiment shown in the block diagram of FIG. 3, the invention provides a system 300 for reducing data loss in a disk array 305 comprising a computer 330 operable for computing redundant data of the user data stored in disk array 305, a storage unit 310 operable for periodically storing the computed redundant data into data blocks 312 located on at least one disk 315, a monitor 320 operable for monitoring the disks 311 in the disk array 305 for a number of concurrent actual and predicted disk failures to occur, a directory 325 operable for determining which of the data blocks 312 comprise redundant data that have been altered since an immediate previous time the redundant data was stored wherein a portion of the redundant data is considered altered if the corresponding portion of the user data is altered, a computer 330 also operable for recomputing altered portions of the redundant data and a controller 335 operable for updating the data blocks 312 with the recomputed redundant data when said number of concurrent disk failures occur and less than a fraction of the redundant data has been altered, and at least one replacement disk 340 operable for storing reconstructed data previously stored on a failed disk, wherein the directory 325 is operable for marking the recomputed redundant data, and wherein the disk array 305 comprises one of the standard RAID arrays [1].

The invention provides a system 300 having a directory 325, preferably in the form of a bitmap that tracks the data blocks (strips) 312 comprising the redundant data that has been updated since the redundant data in the data blocks was last refreshed. During normal operation, whenever a block of user data is updated, the data blocks 312 containing the corresponding redundant data, i.e. the redundant data that is affected by the update, is marked in the directory 325. Periodically and/or when the array 305 is relatively idle, the redundant information is updated for any block 312 that has been marked. Then, that block 312 is unmarked. When one or more disks 315 in the array 305 fails or is predicted to fail soon, the system 300 goes through the same process to bring the redundant information stored in data blocks 312 up-to-date. Once all the redundant information in data blocks 312 is updated, the array 305 can tolerate further disk failures without losing data. Moreover, the computer 330 updates only portions of the redundant data that have been altered, which allows the invention to efficiently use its resources.

However, because the data in system 300 may not be in a form that can be used directly to service incoming requests for user data, the system 300 may have to recompute user data from the redundant data. For example, consider a system with a 4-disk RAID-4 array as array 305 and a 5th disk that contains data blocks 312. Suppose disk 1 in the RAID-4 array fails. Accessing a block on disk 1 would require reading the corresponding blocks from disks 2-4 and performing an exclusive-or operation on the corresponding bits in the blocks read to reconstruct the block that was on disk 1.

Therefore, preferably the system 300 proceeds to rebuild the data that was on the failed disk onto another spare disk 340 rather than to wait until the failed disk is replaced. Alternatively, the data can be recovered onto the disk 315 holding the extra redundant information, assuring that data redundancy is preserved throughout the rebuild process by, for example, allocating temporary buffers needed for the rebuild in non-volatile storage.

If the fraction of blocks 312 that are marked exceed some threshold value (e.g., >0.25), the system 300 could choose to recompute and rewrite all the redundant information, if doing so is more efficient. Similarly, if the fraction of marked blocks 312 exceeds some other threshold value (e.g. >0.25), the system 300 could choose to immediately recover the data that was on the failed disk if this would achieve complete data redundancy earlier. An enhancement provided by the system 300 is that it maintains some update statistics (e.g., time since last update) that can be used to predict how likely a block 312 will be updated again in the near future. Such statistics are stored in temporary storage such as semiconductor memory in storage unit 310. When the redundant information stored in blocks 312 is to be updated, the system 300 can use such information to first focus on the blocks 312 that are less likely to be updated again. For example, because data usage tends to exhibit temporal locality of reference, a block that has been updated recently will tend to be updated again soon. System 300 would therefore first focus on blocks 312 containing redundant that have not been updated recently.

Similarly, whenever the system 300 is relatively idle, it preferably chooses to update those marked blocks 312 that are less likely to be updated again. This enhancement further reduces the amount of redundant data that has to be updated when disk failures occur, and it does so with little impact on foreground performance, i.e. the performance in servicing incoming requests. Preferably, the directory 325 is in non-volatile storage so that it is not lost when a power failure occurs. But if the directory 325 is lost, the system 300 can initialize the directory 325 by recomputing all the redundant information and storing them in blocks 312.

The system 300 applies to any disk array 305 including any one of the standard RAID arrays [1] and combinations of such (e.g. RAID-10, RAID-51, RAID-55). In other words, the redundant data stored in blocks 312 can also be maintained for user data that is stored in multiple RAID arrays, including those that are geographically distributed. Also, disk 315 can be distant from disk array 305.

More generally, suppose that a disk array 305 comprises d disks containing user data and r disks containing redundant data. The redundant data can be used to recover all the user data so long as the number of disk failures does not exceed f For example, in RAID-4, r=1,f=1 and the redundant disk will contain the parity of the data on the d disks. Furthermore, f may vary depending on which of the disks fail. For example, in RAID-1, r=d, f varies from 1 to d and the redundant data is a full copy of the user data. Suppose further that to tolerate fₐ additional disk failures requires dₐ additional disks 315 to store the extra redundant information. For example, in RAID-4, to tolerate an additional failure (fₐ=1) using the EvenOdd code [4] or X-Code [5], an additional disk (dₐ=1) is required. In RAID-1, to tolerate up to f additional failures using double mirror requires d additional disks (dₐ=d).

The invention periodically computes and stores the additional redundant data on the dₐ disks 315. Then when f concurrent actual and predicted disk failures occur, the system 300 retrieves the directory 325 to determine which blocks 312 in the dₐ disks 315 contain additional redundant data that has been updated since the last time the corresponding blocks 312 were updated. The system 300 then recomputes the additional redundant data for these blocks 312, updates the blocks, and unmarks them in the directory 325. When there are less than f concurrent disk failures, the system 300 could also update the additional redundant data as a factor of safety. Once the additional redundant data on the dₐ disks is updated, the system 300 is able to tolerate additional fₐ disk failures without losing any user data.

While the above has described disk failures in a disk array 305, it should be apparent to one skilled in the art that the same ideas can be applied to reduce data loss in other distributed systems such as clusters of storage controllers and when other storage devices such as those based on MEMS (micro-electro-mechanical systems) are used.

The advantages of the invention are numerous. Currently, to increase the number of disk failures that a disk array can tolerate without losing user data, it is necessary to use more disk space to store more redundant data, and more importantly, the additional redundant data would have to be computed and updated every time the user data is written. This is very costly (e.g., multiple reads and multiple writes). Therefore, most systems tolerate only a single disk failure. However, multi-disk failures are increasing and they are costly. In one aspect, the invention makes it possible to achieve higher levels of fault tolerance without incurring significant extra disk space and operations to maintain the redundant data. In another aspect, the invention reduces the time and data processing needed to re-achieve desired levels of data redundancy after one or more disks 315 in a disk array 305 has failed in order to reduce the chance and amount of data loss.

In order to achieve this, the invention periodically computes redundant data and stores the computed data preferably on the spare disks in the system. Then when needed (on demand) such as when disks fail or are predicted to fail, the invention updates the redundant data by recomputing and writing only the parts that have changed. Since the amount of user data that is updated tends to be very small, on the order of a few percent (<5%) per day [3], this, in effect, dramatically decreases the time needed to re-achieve data redundancy. Compared to a traditional system that always keeps all the redundant data updated, the invention, in contrast, provides performance in which much fewer operations are performed since many blocks containing user data are written more than once (the write traffic is much higher than the write working set). Moreover, the invention allows the system 300 to defer most of the operations for updating the redundant data to a more convenient time so that there is dramatically less impact on foreground performance.

Currently, most of the data loss situations in the widely-used RAID-5 array [1] result (1) when there is more than one concurrent disk failure, and (2) when there is one disk failure followed by a subsequent failed sector read on another disk during the rebuild process to recover the user data that was on the failed disk. The invention makes it unnecessary to read most (>95%) of the user data to re-achieve data redundancy after a disk failure in the RAID-5 array. It therefore dramatically reduces the second type of data loss situations. By greatly reducing the amount of data that has to be processed to re-achieve data redundancy, the invention also re-establishes data redundancy much quicker so that the first type of data loss situations is much less likely to occur.

While the invention has been described in terms of preferred embodiments, those skilled in the art will recognize that the invention can be practiced with modification within the spirit and scope of the appended claims.

### REFERENCES

[1] P. M. Chen et al, “RAID: High-Performance, Reliable Secondary Storage,” ACM Computing Surveys, 26, 2, pp. 145-185, June 1994.
[2] J. Menon et al., “A Comparison of Sparing Alternatives For Disk Arrays,” Proceedings of the 19th Annual International Symposium on Computer Architecture, pp. 318-329, 1992.
[3] W. W. Hsu et al., “Characteristics of I/O Traffic in Personal Computer and Server Workloads,” IBM Systems Journal, 42, 2, 2003.
[4] M. Blaum et al, “The EVENODD code and its generalization: An Efficient Scheme for Tolerating Multiple Disk Failures in RAID Architectures,” High Performance Mass Storage and Parallel I/O: Technologies and Applications, Ch. 14, pp. 187-208, 2001.
[5] L. Xu et al., “X-Code: MDS Array Codes With Optimal Encoding,” IEEE Transactions an Information Theory, 45, 1, pp. 272-276, 1999.
[6] G. F. Hughes et al., “Improved Disk-Drive Failure Warnings,” IEEE Transactions on Reliability, Vol. 51, No. 3, September 2002.

1. A method for reliably storing data on disks, said method comprising:
writing a data block to be stored in a disk array;
combining an address of said data block to a set of retrievable addresses;
periodically computing a function of said data stored in said disk array;
storing the computed function on at least one spare disk;
on a disk failure in said disk array, updating the computed function using said set of retrievable addresses to recompute only altered portions of said function; and
deleting said set of retrievable addresses.

2. The method of claim 1, wherein said disk failure includes disk failures that are predicted to occur.

3. The method of claim 1, wherein said function comprises a mathematical function.

4. The method of claim 1, wherein said function comprises an error correcting code.

5. The method of claim 1, wherein said address of said data block comprises an address of a corresponding portion of the computed function and said set of retrievable addresses comprises a set of addresses that describe portions of the computed function requiring updating.

6. The method of claim 1, wherein said disk array comprises at least one a RAID array.

7. The method of claim 1, further comprising reconstructing data stored on a failed disk onto at least one replacement disk.

8. The method of claim 1, wherein said steps of updating and deleting are skipped if said set of retrievable addresses exceeds a fraction of said data stored in said disk array.

9. The method of claim 1, wherein altered portions of said computed function are updated whenever a load on said disk array is below a threshold value.

10. The method of claim 1, wherein altered portions of said computed function that are less likely to be altered again are preferentially updated.

11. A method of reducing data loss in a disk array, said method comprising:
periodically storing redundant data into data blocks located on a spare disk;
monitoring said disks in said disk array for disk failures to occur;
determining which of said data blocks contain redundant data that has been altered since an immediate previous time said redundant data was stored;
recomputing altered portions of said redundant data; and
storing the recomputed altered portions in said data blocks.

12. The method of claim 11, wherein said disk failures include disk failures that are predicted to occur.

13. The method of claim 11, further comprising updating said data blocks with altered redundant data when said disk failures have occurred.

14. The method of claim 11, wherein said disk array comprises at least one a RAID array.

15. The method of claim 11, further comprising reconstructing data stored on a failed disk onto at least one replacement disk.

16. The method of claim 13, wherein said step of updating said data blocks comprising altered redundant data is skipped if a number of said data blocks exceeds a fraction of said data stored in said disk array.

17. The method of claim 12, wherein said data blocks containing altered redundant data are updated whenever the load on the disk array is below a threshold value.

18. The method of claim 17, wherein the data blocks containing altered redundant data that is less likely to be altered again are preferentially updated.

19. A system for reducing data loss in a disk array comprising:
a storage unit operable for periodically storing redundant data into data blocks located on a spare disk;
a monitor operable for monitoring the disks in the array for disk failures to occur;
a directory operable for determining which of said data blocks contain redundant data that has been altered since an immediate previous time said redundant data was stored; and
a computer operable for updating only portions of said redundant data that has been altered.

20. The system of claim 19, wherein said disk failures monitored include disk failures that are predicted to occur.

21. The system of claim 19, further comprising a controller operable for updating said redundant data when said disk failures have occurred.

22. The system of claim 19, further comprising at least one replacement disk operable for storing reconstructed data previously stored on a failed disk.

23. The system of claim 19, wherein said directory is operable for marking the recomputed redundant data in said directory.

24. The system of claim 19, wherein said disk array comprises at least one a RAID array.

25. The system of claim 19, further comprising a controller operable for updating said redundant data whenever a load on said disk array is below a threshold value.

26. The system of claim 25, wherein said controller preferentially updates redundant data that is less likely to be altered again.

27. A system of reducing data loss in a disk array comprising:
means for periodically storing redundant data into data blocks located on a spare disk;
means for monitoring said disk for disk failures to occur;
means for determining which of said data blocks contain redundant data that has been altered since an immediate previous time said redundant data was stored;
means for recomputing altered portions of said redundant data in said data blocks; and
means for storing the recomputed altered portions in said data blocks.
